(19) United States
(12) Patent Application Publication
(10) Pub. No.: US 2008/0156588 A1
(43) Pub. Date: Jul. 3, 2008

(54) PIVOTALLY FOLDABLE LADDER MODULE APPARATUS, AND METHOD OF USING SAME

(75) Inventor: Robert Butcher, Flushing, MI (US)

Correspondence Address: CARRIER BLACKMAN AND ASSOCIATES, 24101 NOVI ROAD, SUITE 100, NOVI, MI, 48375, US

(73) Assignee: EASTMAN OUTDOORS INC., Flushing, MI (US)

(21) Appl. No.: 11/966,127

(22) Filed: Dec. 28, 2007

Related U.S. Application Data
(60) Provisional application No. 60/882,924, filed on Dec. 30, 2006.

(51) Int. Cl. E06C 1/34

(52) U.S. Cl. 182/200

(57) ABSTRACT

A pivotally foldable ladder module apparatus, for use by hunters and wildlife enthusiasts, includes upper and lower body segments which are pivotally connected to one another. The apparatus includes a locking fastener for temporarily fixing the position of the lower body segment relative to the upper body segment. The apparatus may also include an adjustable strap attached to a central shaft of the upper body segment, to permit fastening of the apparatus to a tree. The apparatus is pivotally movable between an extended position and a folded position used for storage and transport. Each segment includes a central shaft, and a pair of tree-contacting bracket members for aligning the apparatus with a tree. When the apparatus is in the folded position, the tree-contacting bracket members are displaced from one another, and the respective central shafts are spaced apart from one another and are oriented substantially parallel to one another.

### CROSS REFERENCE TO RELATED APPLICATIONS

This application claims the benefit of U.S. Provisional application No. 60/882,924 filed 30 Dec. 2006.

### BACKGROUND OF THE INVENTION

1. Field of the Invention

The present invention relates to a ladder module apparatus for attaching to a tree. The apparatus is adapted to assist a user in climbing to a desired position in the tree, such as a tree stand or blind. More particularly, the present invention relates to a ladder module apparatus having two main body portions which are pivotally connected to permit folding and unfolding of the apparatus, for easy transportation of the apparatus. In addition, apparatus of this type tend to be used in remote locations requiring that the apparatus be safe, durable, reliable, simple and easily transportable.

2. Description of the Background Art

When hunting ground-dwelling game, such as deer and the like, it is desirable for a hunter to avoid notice by the quarry. Towards that end, a hunter of such ground-dwelling game will often place himself above the normal field of perception of the quarry by placing a platform or hunting stand in a tree, from which the hunter may wait, undetected and observe and/or shoot the quarry.

The tree stand used by a hunter is often a portable device which is transported by the hunter to the desired location in the wilderness, and set up to the desired elevation in the tree. Depending on the location of the tree stand and local regulations, it may be necessary to remove the tree stand. For example, on private property, the tree stand may remain in place for the entire hunting season, while on public land, it may be a requirement that a tree stand be removed after a certain period of time. In either situation, it is desirable to limit the number of trips made to this location by the hunter since the game or quarry in the area may become aware, through scent or noise, that there is human activity in the area.

Modular ladder systems are often used in conjunction with tree stands, to enable the hunter access to and from the tree stand which is situated in an elevated position in the tree. To be elevated from the ground is a beneficial position for the tree stand user since the user is out of the normal visual perception of the quarry and human scent will be more difficult for the quarry to detect.

Tree stands can be used for many purposes, such as hunting, but can also be used by others, such as photographers or naturalists, for the observation of wild animals while remaining undetected. The elevated position gives the user the advantage of line of sight, or being able to see farther and being prepared for the animal when it gets closer to the tree stand location.

Once a tree stand is located, the user will need access to the elevated position. There are several ways that the tree stand user can gain access to the stand, a conventional ladder may be placed against the tree, and tree pegs can be installed into the tree trunk or some other modular ladder system installed. Each of these methods has a disadvantage. For example, the conventional ladder is not designed for use on uneven ground or designed for use against an uneven surface such as a tree. Tree pegs cause damage to the tree since the pegs are essentially large nails that are driven into the trunk. Other modular ladder systems often rely upon the ladder hooking over a branch of the tree for stability or are cumbersome and awkward to transport. In addition, the desired position may be at a height that a conventional ladder can reach. It may be necessary to provide more than one ladder apparatus to reach the desired position.

Since the tree stand or other blind is usually placed at an elevation that would cause substantial injury to the user if there were to be a fall, safety is an important issue when using the ladder apparatus and tree stand. Usually, the tree stand is used in a remote location and first aid may be far away. Therefore, the equipment that is used must be safe, simple and easily transportable. Falling from a ladder or tree stand would result in injuries, but most hunting deaths are the result of heart attacks. Long hikes with heavy equipment can put stress on the hunter. Therefore, the lighter and more compact the ladder apparatus, the better. In addition, when in the tree stand and on the ladder, it is highly recommended that the user employ a full body harness tethering the user to the tree.

Several different modular ladders and ladder systems are known for use by hunters or naturalists. Examples of some of the known modular ladder systems include those described in U.S. Pat. No. 4,263,983 to Norton, U.S. Pat. No. 5,509,466 to Prejean, U.S. Pat. No. 5,655,623 to Skyba, U.S. Pat. No. 5,711,399 to Wayne-Prejean, U.S. Pat. No. 5,752,580 to Jenkins, Jr., U.S. Pat. No. 5,779,001 to Skyba, U.S. Pat. No. 5,806,626 to Jenkins, Jr., U.S. Pat. No. 6,547,035 to D'Acquisto and U.S. Pat. No. 6,688,975 to Skipper.

At times, modular ladders of a type having a main central shaft portion with rungs extending transversely outwardly from the central shaft are referred to in the art as “climbing sticks”. The two Skyba references mentioned above disclose climbing stick type ladders having a central shaft with a pivot joint to permit folding of the ladder apparatus with a locking collar that slides over the joint to lock it in place.

Although the known devices have some utility for their intended purposes, a need still exists in the art for an improved “climbing stick” type ladder apparatus which can be folded into a compact configuration for storage and transport, and which can be expanded into a full-size configuration for use, yet which also includes improved stabilizing structures at both ends. In particular, there is a need for an improved “climbing stick” type ladder apparatus which will overcome the shortcomings encountered in the known art.

### SUMMARY OF THE INVENTION

In an illustrative embodiment hereof, a pivotally foldable ladder module apparatus includes an upper body segment and a lower body segment which are pivotally connected to one another. The apparatus may also include a locking fastener, usable to temporarily fix the position of the lower body segment relative to the upper body segment. The apparatus may also include an adjustable strap attached to a central shaft of the upper body segment, to permit fastening of the apparatus to a tree. The ladder module apparatus is pivotally movable between an extended position and a folded position which is used for storage and transport.

Each segment of the apparatus includes a central shaft and a pair of tree contacting bracket members for aligning the apparatus with a tree. When the apparatus is in the folded, collapsed position, the tree-contacting bracket members are displaced from one another, and the respective central shafts are spaced apart from one another and are oriented substantially parallel to one another.

Accordingly, it is an object of the invention to provide a climbing stick type ladder apparatus including a central pivot joint as well as improved stabilizing structures at upper and lower ends thereof.

It is a further object of the invention to provide a kit of components that is compact while stored and then erected on site. The kit comprising a ladder apparatus of durable construction, reliably made, simple to set up and is easily transportable.

It is a further object of the invention to provide a ladder apparatus that easily cooperates with other like ladder apparatus to form a series of ladders up a tree to the tree stand or desired position.

Although the known climbing sticks have some utility in the art for their intended purposes, a need still exists in the art for an improved ladder apparatus climbing stick. In particular, there is a need for an improved ladder apparatus which is compact, easily transportable, cooperates with like ladder apparatus, is durable, and has improved stability.

### BRIEF DESCRIPTION OF THE DRAWINGS

A preferred embodiment of the invention of a climbing stick type ladder apparatus and method of using it will be better understood when consideration is given to the detailed description of the accompanying drawings, wherein like elements bear like reference numerals and where:

FIG. 1A is a perspective view of a ladder module apparatus according to a selected illustrative embodiment of the invention, shown in an unfolded configuration and ready for use, and with a support strap omitted from the drawing for purposes of illustration.

FIG. 1B is a perspective view of the ladder apparatus of FIG. 1A, shown in a folded configuration for storage and transport.

FIG. 2A is a side plan view of the ladder apparatus, shown in the unfolded configuration.

FIG. 2B is a side plan view of the ladder apparatus of FIG. 2A, shown in an intermediate, partially folded configuration.

FIG. 2C is a side plan view of the ladder apparatus of FIGS. 2A-2B, shown in the folded configuration.

FIG. 3A is a rear plan view of the ladder apparatus, shown in the unfolded configuration.

FIG. 3B is a rear plan view of the ladder apparatus of FIG. 3A, shown in the folded configuration.

FIG. 4 is a first environmental perspective view of the ladder apparatus shown installed on a tree.

FIG. 5 is a second environmental perspective view of the ladder apparatus shown installed on a tree, showing details of the support strap and tightening mechanism.

FIG. 6 is a detail perspective view of a fastening member usable to temporarily lock the ladder apparatus in the unfolded configuration.

### DETAILED DESCRIPTION OF THE INVENTION

It should be understood that only structures considered necessary for clarifying the invention are described herein. Other conventional structures, and those of ancillary and auxiliary components of the system, are assumed to be known and understood by those skilled in the art.

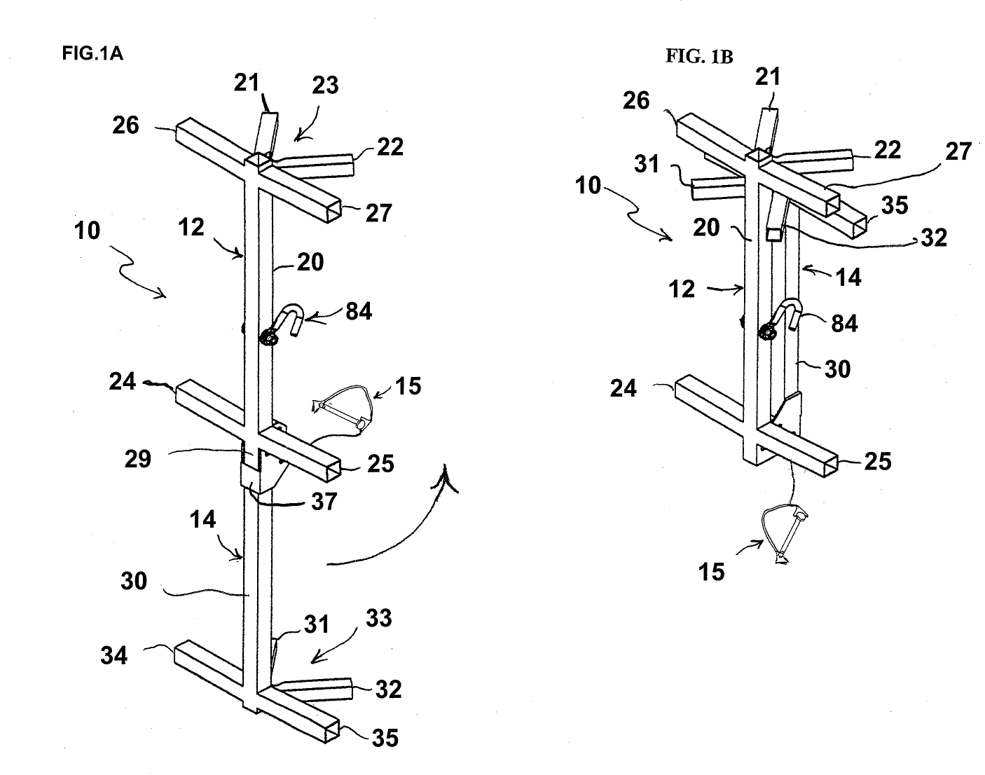

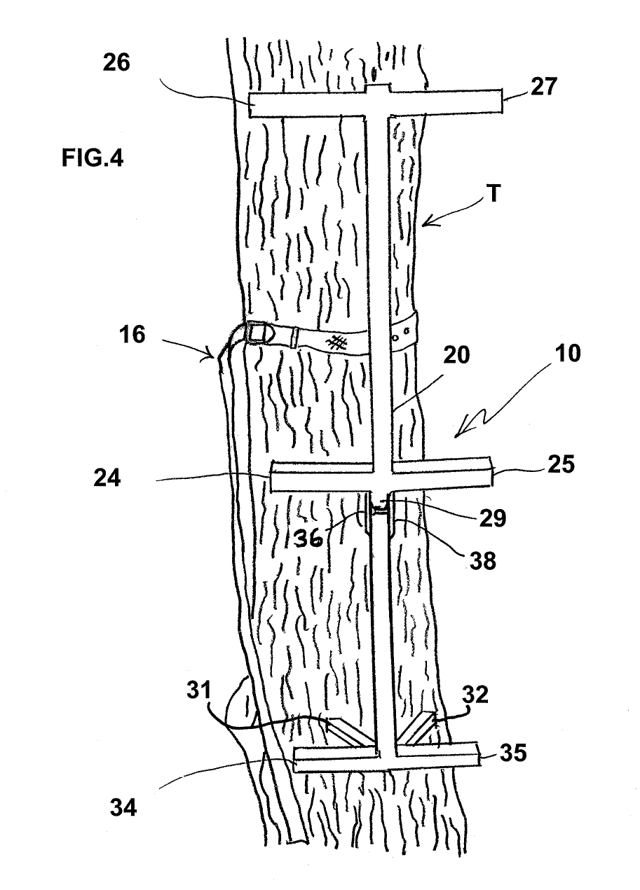

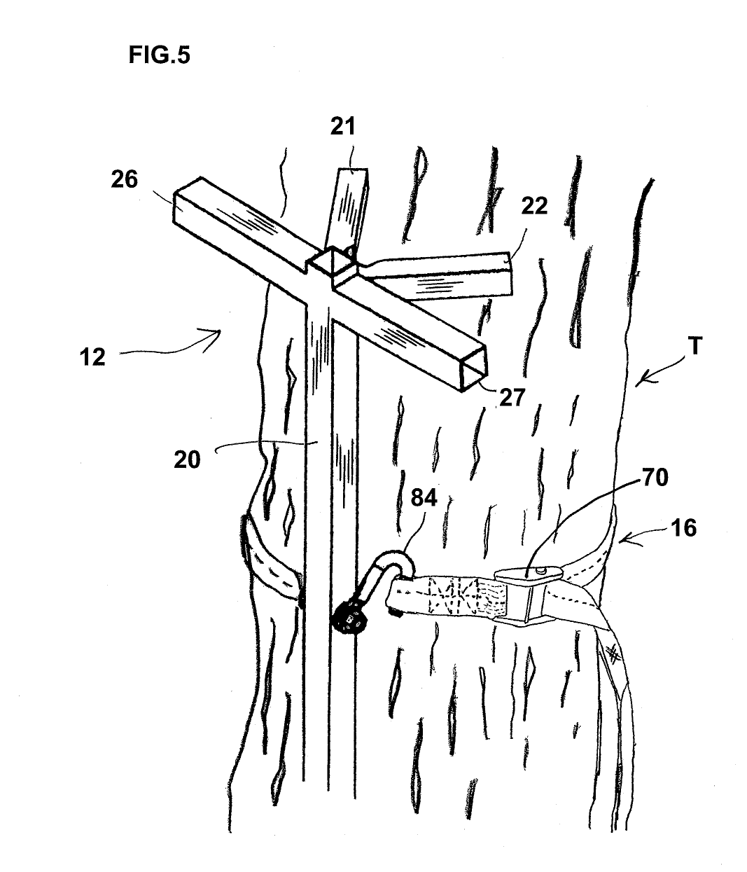

Referring now to the drawings, particularly FIG. 1A, a pivotally foldable ladder apparatus according to an illustrative embodiment of the invention is shown as 10. The ladder apparatus 10 comprises an upper body segment 12 and a lower body segment 14, which pivotally connect to one another. The apparatus 10 may also include a locking fastener 15, used to temporarily affix the position of the lower body segment 14 relative to the upper body segment 12. The apparatus may also include an adjustable strap 16, best seen in FIGS. 4, 5, operatively attached to an upper central shaft 20 of the upper body segment 12 to permit fastening of the apparatus 10 to a tree T.

The ladder apparatus 10 is pivotally movable between an open, unfolded and extended position, best seen in FIGS. 1A, 2A and 3A, and a folded position which is used for storage and transport, best seen in FIGS. 1B, 2C and 3B.

Each of the upper and lower body segments 12, 14 includes a central shaft 20, 30 respectively, and a pair of tree contacting bracket members, first and second bracket members 21, 22 on upper segment 12 and third and fourth bracket members 31, 32 on the lower segment 14. The brackets 21, 22, 31, 32 are provided to align, support and stabilize the ladder apparatus 10 with the tree T. In addition, when the ladder apparatus 10 is employed and attached to a tree T, the brackets 21, 22, 31, 32 not only stabilize the ladder apparatus 10 but space the rungs 26, 27, 24, 25, 34, 35 from the tree which allows a user of the ladder apparatus 10 to “feel” the rungs 24, 25, 26, 27, 34, 35 with his feet. Often, the user will not be able to see the rungs 24, 25, 26, 27, 34, 35 whether because of darkness or the position of the ladder apparatus 10. This gives the user the ability to easily find and remain on the rungs 24, 25, 26, 27, 34, and 35 and provide a safer ladder apparatus 10. When the apparatus 10 is in the folded collapsed position, the bracket members 21, 22, 31, 32 are displaced from one another, and the respective central shafts 20, 30 are spaced apart from one another, and are oriented substantially parallel to one another.

As noted above, the upper body segment 12 includes an upper central shaft 20, provided to be oriented substantially vertically in use, as shown in FIGS. 4 and 5. The upper body segment 12 also includes a first set of step rungs, first and second rungs 24, 25 extending outwardly in opposite directions from a bottom portion of the central shaft 20, and a second set of step rungs, third and fourth rungs 26, 27 extending outwardly in opposite directions from a top portion of the central shaft 20.

The tree contacting bracket members 21, 22 of the upper segment 12 comprise arms that extend forwardly and outwardly forming a substantially V-shape from a top portion of the central shaft 20, and define an upper trunk receiving space 23 therebetween.

The upper body segment 12 also includes a pivot boss 28 integrally attached to the bottom portion of the central shaft 20 and extending forwardly thereon. The pivot boss 28 has at least one hollow bore formed therethrough to receive a pivot bolt 80. The upper body segment 12 further includes a strap support structure, best seen in FIG. 5, including a pair of hooks 82, 84 attached to the central shaft 20 for supporting the strap 16, which is used to attach the apparatus to a trunk portion of a tree T. The strap 16 is preferably provided with a tensioning device 70 to tighten strap 16 around tree T for the safety of the user of the ladder apparatus 10. The strap 16 is tightened to ensure trunk receiving spaces 23, 33 and tree contacting bracket members 21, 22, 31, 32 are in the proper positions. Hooks 82, 84 are employed for easy attachment of the strap to the ladder apparatus 10. It can be difficult to reach around the trunk of some large trees, and the hooks allow the user to secure one end to the ladder apparatus 10 and pass the strap around the trunk to attach to the opposite hook.

The lower body segment 14 includes the lower central shaft 30, as noted above, and also includes a third set of step rungs, fifth and sixth rungs 34, 35 extending outwardly in opposite directions from a bottom portion of the central shaft 30. The lower body segment 14 also includes tree contacting bracket members comprising arms, third and fourth bracket members 31, 32, extending forwardly and outwardly from a bottom portion of the central shaft 30 and defining a lower trunk receiving space 33 therebetween. When folded, the lower trunk receiving space 33 receives a portion of the upper central shaft 20 as can be seen in FIG. 1B.

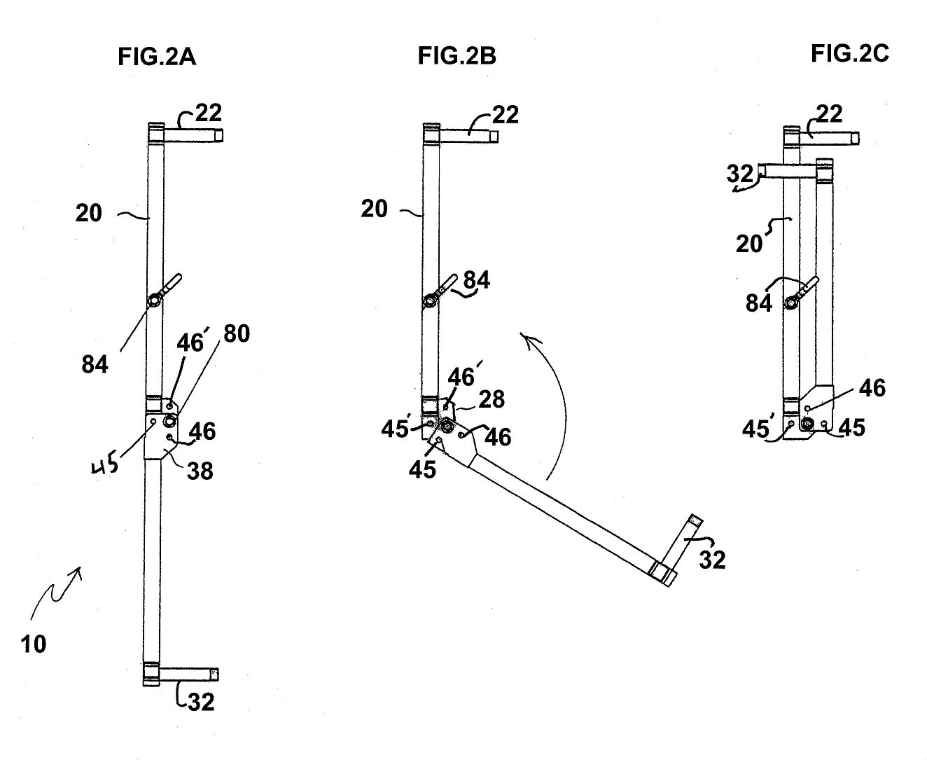

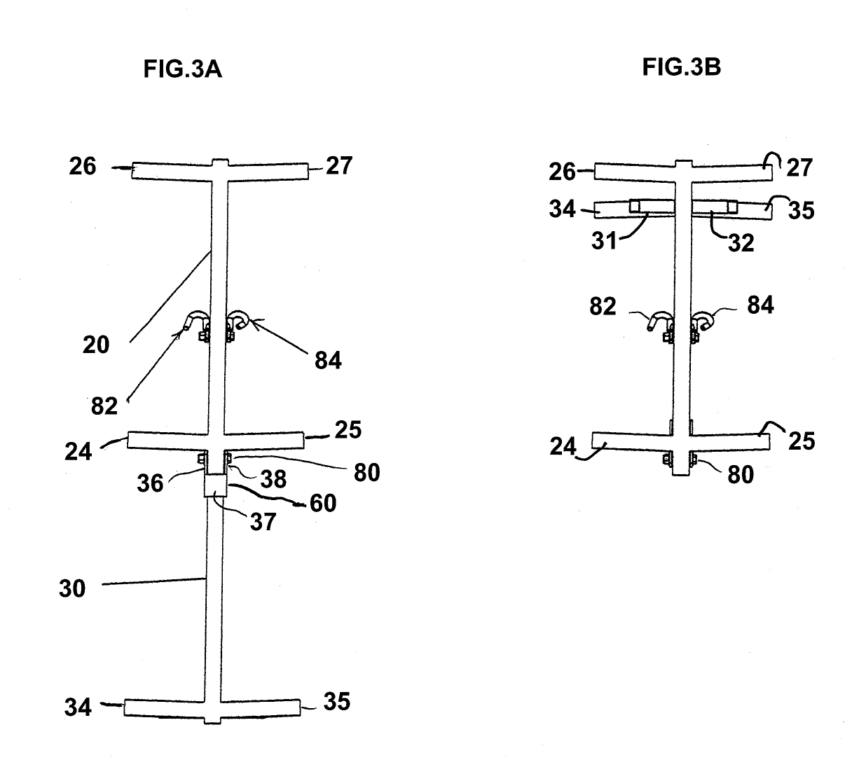

The lower body segment 14 further includes a pair of parallel spaced apart connector flanges 36, 38 extending forwardly and upwardly from a top portion of the lower central shaft 30, and these connector flanges may be interconnected by a bight 37 (FIG. 3A) to form a unitary bracket 60 which is welded on to, or otherwise affixed to the top of the lower central shaft 30. These connector flanges 36, 38 of bracket 60 define a hollow receptacle therebetween (FIG. 2B) for receiving a lower end portion 29 of the upper body segment 12. The connector flanges 36, 38 may have respective first set of holes formed therethrough which are alignable with the hollow bore of the pivot boss 28, and which receive the pivot bolt 80 therethrough. In addition, the flanges 36, 38 and pivot boss 28 include at least one additional set or second set of holes 45, 45′ for the locking fastener 15 to enter and lock the upper and lower body segments 14, 12 relative to each other. Preferably, a third set of hole 46, 46′ are provided in the boss 28 and flanges 36, 38 to lock the ladder apparatus in the folded position, as best seen in FIG. 2C.

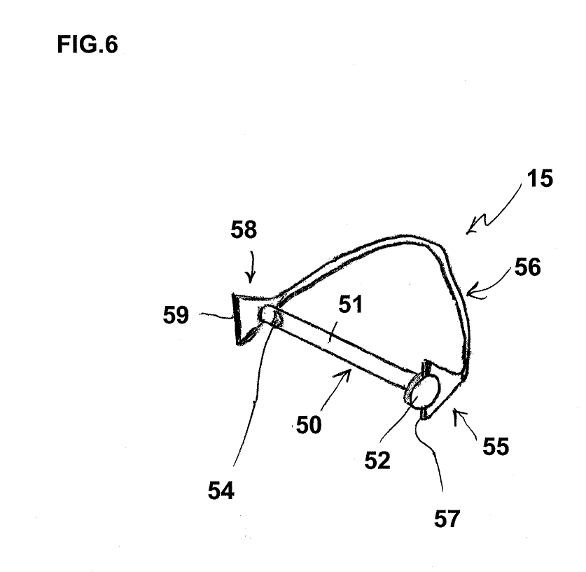

Referring now to FIG. 6, the structure of the locking fastener 15 will now be described. As previously noted, the locking fastener 15 is usable to temporarily fix the position of the lower body segment 14 relative to the upper body segment 12. The fastener 15 includes a locking body 50 including a cylindrical main shaft 51 with an enlarged head 52, and a connection member 56 formed from spring wire which is attached to the main shaft.

The main shaft 50 also has a notch 54 formed in an end portion thereof opposite the head 52. A small through hole is bored transversely through the head 52, and this through hole receives one portion 57 of a first triangular end portion 55 of the connection member 56 therethrough.

The connection member is substantially U-shaped, and has a second triangular end portion 58 at an end opposite the first triangular end portion 55. In order to temporarily lock the locking fastener in place, a cross piece 59 of the second triangular end portion is placed into the notch 54 of the main shaft 50. It will be understood that other locking fasteners may be used besides the fastener 15.

It should be understood that a ladder apparatus 10 according to the invention is not generally used alone as a single unit, but rather, multiple ladder apparatus 10 may be used to fasten sequentially to a tree, in order to allow a user to climb to the desired position in the tree. In addition, if desired, these multiple ladder apparatus may be used in conjunction with a tree stand mounted at a vertical elevation from the ground, where the tree stand is used for hunting, or for observation of wildlife. In addition, it may be possible to “climb” the ladder apparatus 10 up a tree instead of employing multiple ladder apparatus 10 under certain conditions. For example, the presence of a large branch or other location where a user could safely wait, would allow the user to reposition the ladder apparatus 10 higher up the tree T to get to the desired location.

Although the invention has been described herein with respect to a number of specific embodiments, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the invention.

What is claimed is:

1. A pivotally foldable climbing stick apparatus, comprising an upper body segment, a lower body segment pivotally connected to said upper body segment, and a locking fastener for temporarily fixing the position of the lower body segment relative to the upper body segment, wherein said lower body segment is pivotally movable between an extended position and a folded position,
said upper body segment comprising:
an upper central shaft;
a first set of step rungs extending outwardly in opposite directions from a bottom portion of said upper central shaft;
a second set of step rungs extending outwardly in opposite directions from a top portion of said upper central shaft;
an upper pair of tree-contacting bracket members extending outwardly from a top portion of said upper central shaft and defining a trunk-receiving space therebetween;
a pivot boss attached to the bottom portion of said upper central shaft and extending forwardly thereon, said pivot boss having a hollow bore formed therethrough to receive a bolt;
and
a strap support structure attached to said upper central shaft for supporting a strap used to attach the apparatus to a tree trunk;
and said lower body segment comprising:
a lower central shaft;
a third set of step rungs extending outwardly in opposite directions from a bottom portion of said lower central shaft;
a lower pair of tree-contacting bracket members extending outwardly from a bottom portion of said lower central shaft and defining a trunk-receiving space therebetween;
a pair of parallel spaced apart connector flanges extending upwardly from a top portion of said lower central shaft, said connector flanges defining a hollow receptacle therebetween for receiving a lower end of said upper body segment, said connector flanges having respective holes formed therethrough which are alignable with the hollow bore of the pivot boss.

2. The ladder apparatus of claim 1, wherein said upper and lower tree contacting bracket members each comprise a pair of arms extending in a V-shape.

3. The ladder apparatus of claim 1, wherein said strap support structure comprises a pair of hooks, one of each said hook on either side of said upper central shaft.

4. The ladder apparatus of claim 1, wherein said locking fastener engages a first set of holes in said flanges and said pivot boss to affix the upper and lower central shafts in an extended position.

5. The ladder apparatus of claim 1, wherein said locking fastener engages a second set of holes in said flanges and said pivot boss to affix said upper and lower central shaft in a folded position.

6. The ladder apparatus of claim 1, wherein said first and second set of rungs comprise opposing rungs extending from either side of said upper central shaft.

7. The ladder apparatus of claim 1, wherein said strap support structure comprises a hook on each side of said upper central shaft between said first and second rungs and further including a strap with a tensioner for tightening the strap around a tree trunk.

8. The ladder apparatus of claim 1, wherein said upper body segment and said lower body segment are pivotally movable such that said upper and lower tree contacting brackets are spaced from each other in the folded position, said lower tree contacting bracket receiving said upper central shaft.

9. The ladder apparatus of claim 1, wherein said third set of rungs comprises opposing rungs extending from opposite sides of said lower central shaft.

10. A foldable climbing stick apparatus, comprising an upper body segment, a lower body segment pivotally connected to said upper body segment, and said lower body segment is pivotally movable between an extended position and a folded position,
said upper body segment comprising:
an upper central shaft;
a first set of step rungs extending from a bottom portion of said upper central shaft;
a second set of step rungs extending from a top portion of said upper central shaft;
a pair of tree-contacting bracket members extending outwardly from a top portion of the central shaft and defining a substantially V-shaped trunk receiving space therebetween;
a pivot boss attached to the bottom portion of said upper central shaft, and
a strap support structure; and
said lower body segment comprising:
a lower central shaft;
a third set of step rungs extending outwardly from a bottom portion of said lower central shaft;
a pair of tree-contacting bracket members extending outwardly from a bottom portion of said lower central shaft and defining a substantially V-shaped trunk-receiving space therebetween;
a pair of parallel spaced apart connector flanges extending from said lower central shaft, said connector flanges defining a hollow receptacle therebetween, said connector flanges further having holes formed therein which align with a hollow bore in said pivot boss to form a pivot connection.

11. The ladder apparatus of claim 10, wherein said strap support structure comprises a pair of hooks, one of each said pair of hooks on either side of said upper central shaft.

12. The ladder apparatus of claim 10, wherein a locking fastener affixes said upper and lower body segments relative to one another, said locking fastener engages a set of apertures in said boss and said flanges to affix said body segments in said extended position.

13. The ladder apparatus of claim 12, wherein said locking fastener engages another set of apertures in said boss and said flanges to affix said body segments in a folded position.

14. The ladder apparatus of claim 10, wherein said strap support structure comprises a hook on each side of said upper central shaft between said first and second set of step rungs and further including a strap with a tensioner for tightening the strap around a tree trunk.

15. The ladder apparatus of claim 10, wherein said upper body segment and said lower body segment are pivotally movable such that said upper and lower tree contacting brackets are spaced from each other in the folded position, said lower tree contacting bracket receiving said upper central shaft in said trunk receiving space.

16. The ladder apparatus of claim 10, wherein said first, second and third set of rungs comprise rungs extending outwardly in opposite directions from said upper and lower central shafts.

17. The ladder apparatus of claim 10, wherein said pivot connection includes a bolt engaged in said holes and said bore.

18. The ladder apparatus of claim 10, wherein said flanges further include a bight portion that when formed together comprise a unitary bracket.

19. The ladder apparatus of claim 18, wherein said unitary bracket includes a first set of apertures for locking said upper body and said lower body in a folded position and a second set of apertures for locking said upper body and said lower body in an extended position, said apertures aligning with holes in said boss such that a locking fastener engages said apertures.
